(19) United States
(12) Patent Application Publication
(10) Pub. No.: US 2009/0300820 A1
(43) Pub. Date: Dec. 10, 2009

(54) Patient needs communicator

(76) Inventors: Valerie L. Cansler, Alpharetta, GA (US); Sharon Pamperin, Cumming, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 12/157,034

(22) Filed: Jun. 6, 2008

(51) Int. Cl. A41D 13/12; G08B 23/00; A41D 10/00

(52) U.S. Cl. 2/114; 340/573.1

(57) ABSTRACT

An apparatus for facilitating communication between care giver and patient is provided. The apparatus includes a hospital garment and indicia in communication with the hospital garment. The indicia corresponds to the patient's needs and aids in the rehabilitation and care of the patient.

### BACKGROUND

Timely and adequate communication between medical personnel and patients strongly contributes to optimal diagnosis and treatment. In this regard, a patient should be able to timely and accurately express his or her sensations, experiences and reactions. Similarly, it is essential that medical personnel be able to give proper directions and explanations to patients to meet patient needs and facilitate solutions to patient problems.

In certain particular circumstances, such as when a patient is in the intensive care unit of a hospital, the patient may have an especially difficult time communicating his or her needs and wants because the patient could be intubated with an endotracheal tube, for example, and the tube could pass through the vocal cords and obstruct coherent speech. Alternatively and/or additionally, extreme weakness resulting from lying on a hospital bed for an extended period of time may result in a patient's inability to articulate himself at an adequate volume. Communication between patient and care giver may also prove to be difficult when the patient and care giver speak different primary languages. Each of these circumstances, alone or in combination, can cause delays and misunderstandings which may result in a reduction in therapeutic effectiveness.

In order to solve these barriers, hospitals often sedate patients to keep patients quiet and docile. This, however, is an ineffective way of handling patients because medical evidence has shown that patients tend to heal more quickly when they are not heavily sedated. Additionally, many hospitals utilize expensive electronic equipment to aid in the facilitation of communication between patient and care giver. This, however, is not always feasible in today's economic environment of cost-cutting and forced savings.

Therefore, there remains a need for an effective method of facilitating communication between patient and care giver which is both economical and not harmful to the patient.

### SUMMARY OF INVENTION

The present invention provides for an apparatus for facilitating communication between care giver and patient. The apparatus includes a donnable hospital garment and at least one indicia in communication with the hospital garment. Desirably, the at least one indicia displays at least one patient need and is adapted to aid in the rehabilitation and care of the patient. The at least one indicia may be printed on a hospital garment, desirably upon at least one sleeve, or displaced upon the hospital garment by use of an adhesive.

The hospital garment may be a patient gown, a cover gown, or a surgical gown, and may be made of an SMS material, SFS material, spunbond material, meltblown material, or combinations thereof.

The patient needs displayed on the hospital garment includes food, water, pillows, change of positioning, relief from pain, mucous removal, personal hygiene, medicine, family presence, radio, or television. These patient needs may be grouped into categories, such as for example, comfort or entertainment, and may be displayed as at least one graphical illustration, at least verbal illustration and/or combinations of at least on graphical and at least on verbal illustration, including at least one verbal illustration corresponding to the at least one graphical illustration

Another aspect of the invention provides for an apparatus for facilitating communication between care giver and patient. The apparatus includes a donnable hospital garment, and at least one indicia in communication with the hospital garment. The at least one indicia displays at least one care giver need and is adapted to aid in the rehabilitation and care of the patient.

Yet another aspect of the invention provides for a patient communication bundle for facilitating communication between care giver and patient. The bundle includes a donnable patient hospital garment and a donnable care giver hospital garment. The bundle further includes at least one indicia in communication with the patient hospital garment which displays at least one patient need and is adapted to aid in the rehabilitation and care of the patient, and at least one indicia in communication with the care giver hospital garment which displays at least one care giver need and is adapted to aid in the rehabilitation and care of the patient.

A further aspect of the invention provides for a method of making an apparatus for facilitating communication between care giver and patient. The method includes providing a donnable hospital garment, and placing at least one indicia in communication with the hospital garment, the at least one indicia displaying at least one care giver need or patient need and being adapted to aid in the rehabilitation and care of the patient.

### BRIEF DESCRIPTION OF DRAWINGS

FIG. 1. is a perspective view of a hospital garment having patient need indicia incorporated onto the sleeve of the garment.

FIG. 2 is shows examples of verbal and graphical illustrations of patient and care giver needs and need categories.

### DETAILED DESCRIPTION

The apparatus of the present invention provides for facilitation of communication between a care giver and a patient. The apparatus includes a hospital garment or hospital garments which display patient and/or care giver needs through one or more corresponding indicia, such needs being identifiable to the patient or care giver by pointing to or touching the one or more indicia present on the hospital garment or garments.

The invention will be described with reference to the following description and figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and embodiments.

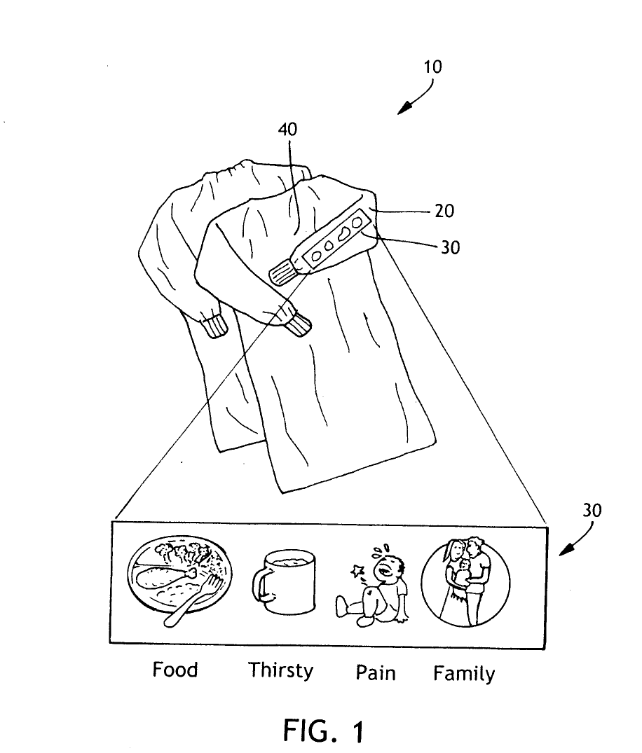

Referring to FIG. 1, a hospital garment 10 according to the invention is provided. The hospital garment 10 includes a main body portion 40 and sleeves 20. The sleeves 20 may be made separately and attached at to the main body portion 40 at a seam or formed as an integral component with the main body portion 40.

The hospital garment 10 is depicted as a surgical gown for illustrative purposes only. The hospital garment 10 may be any type or style of protective covering that is generally worn about the body and includes sleeves. The hospital garment may be worn inside or outside of a hospital setting

It should be appreciated that the type of fabric or material used for the hospital garment 10 is not a limiting factor of the invention. The hospital garment 10 may be made from a multitude of materials, including nonwoven materials suitable for disposable use. For example, gown embodiments of the hospital garment 10 may be made of a stretchable nonwoven material so that the gown is less likely to tear during donning or wearing of the gown. A material particularly well suited for use with the present invention is a three-layer nonwoven polypropylene material known as SMS. “SMS” is an acronym for Spunbond, Meltblown, Spunbond. In forming an SMS material, the three layers are constructed and then laminated together. See for example U.S. Pat. No. 4,041,203 to Brock et al. One particular advantage is that the SMS material exhibits enhanced fluid barrier characteristics. An additional material well suited for use with the present invention is a three layer material known as SFS. “SFS” is an acronym for Spunbond, Film, Spunbond. In forming an SFS material, the three layers are constructed and then laminated together. See for example U.S. Pat. No. 6,037,281 to Mathis et al. It should be noted, however, that other nonwovens and films as well as other materials including wovens, foam/film laminates, and combinations thereof may be used to construct the garment of the present invention. It is also contemplated that the garment may be coated with a liquid impervious coating to prevent fluid absorption into the garment material.

Returning to FIG. 1, regardless of the construction of the hospital garment, the hospital garment may contain indicia 30 on its surface. Although it is desirable that the hospital garment contain indicia on its sleeve, the indicia may be placed anywhere on the hospital garment that is in arm's reach of the patient and/or care giver. The indicia may be printed onto the material of the garment. Suitable, non-limiting methods of printing indicia and images onto hospital garments include flexographic printing, digital printing, offset printing, gravure printing, flexographic printing, digital printing, and the like. Alternatively, indicia may be applied to the garment by use of adhesive. That is, indicia may be printed or otherwise disposed on a flexible material, such as for example, a plastic or polymeric overlay sheet and the sheet may subsequently be applied to the surface of the garment by use of an adhesive. Further, indicia may be printed on a removable surface such as, for example, a surface having Velcro or a hook and loop fastener as known in the art.

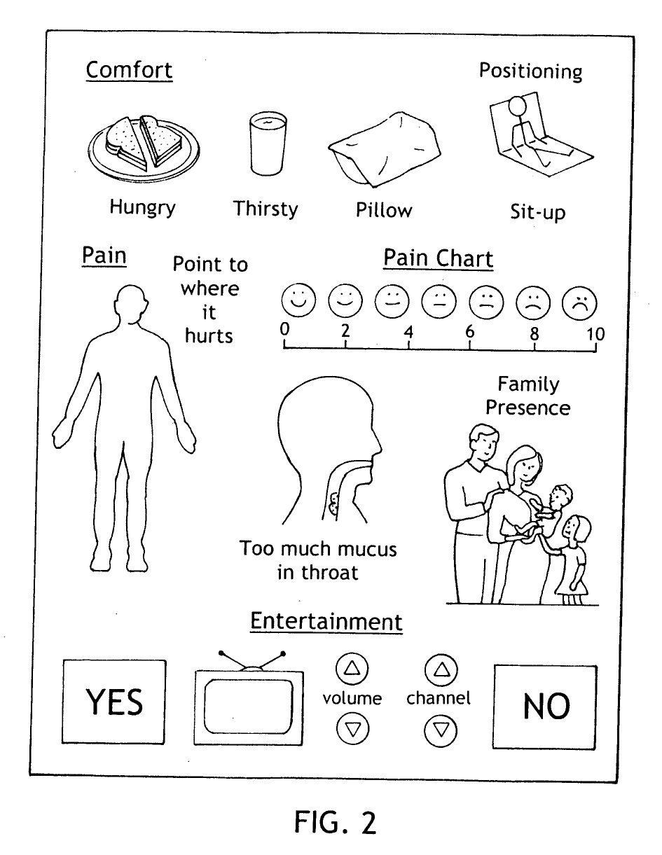

Referring to FIG. 1 and FIG. 2, the indicia present on the surface of the hospital garment designate and correspond to patient needs and/or care giver needs. Non-limiting examples of patient needs include food, water, eyeglasses, wheelchair, change of positioning, pain relief, comfort, rest, mucous removal, television, and family presence. Non-limiting examples of hospital needs include administering medication, changing patient positions, indicating procedure to be performed, or explaining possible results of procedures.

The indicia may take the forms of symbols, pictures, verbal or graphical illustrations, words, alphabets, numerals, or combinations thereof, for example. Additionally, the indicia may be categorized into related needs that a patient and/or care giver may have. For example, a category containing a plurality of verbal and/or graphical illustrations related to food needs could be grouped together on the hospital garment, and additional categories related to comfort and/or entertainment needs could also be present and grouped together on the hospital garment. Other non-limiting examples of categories related to patient and/or care giver needs include vital instructions, non-vital instructions, and transportation of the patient.

Additionally, the various indicia or categories of indicia may be color coded. For example, indicia related to comfort could be colored blue and indicia related to entertainment could be colored red. Regardless of the color chosen for the various indicia or categories of indicia, color coding may facilitate quick identification of symbols to enhance patient care.

In some embodiments where the indicia takes the form of verbal illustrations or words, the indicia may represented in a variety of common languages. Non-limiting examples of common languages include English, French, German, Spanish, and Mandarin.

In some embodiments, the graphical illustrations and verbal illustrations may correspond with each other and be paired together. For example, in FIG. 2, a picture of a sandwich and the English word “Hungry” are paired together. This is useful in those circumstances where a patient speaks a foreign language. For example, a hospital patient who speaks Spanish may not understand the verbal illustration “hungry”, but is likely to understand the graphical illustration corresponding to a sandwich. Therefore, if the Spanish speaking patient has an English speaking care-giver, he or she can point to the illustration of the sandwich on his or her hospital garment and the English speaking care giver will know that the patient is hungry.

In additional embodiments, the indicia present on the hospital garment may include words to facilitate conversational communication. For example, a system or bundle may be provided where both the care giver and patient have indicia present on their respective hospital garments. These indicia may or may not be identical. Under these circumstances, words to facilitate conversational communication may be needed. Non-limiting examples of these words include yes, no, maybe, now, and later.

For example, a care giver may point to a graphical and/or verbal illustration regarding the presence of mucous in the throat. Upon seeing this, the patient might then point to a verbal and/or graphical illustration corresponding to “yes” or “no”. Another non-limiting example involves patient entertainment needs. The care giver, for example, may point to a verbal and/or graphical illustration of a television. The patient could then point to a verbal or graphical illustration corresponding to “yes” or “no” and could then point to a verbal and/or graphical illustration to indicate a need for a change of volume or channel.

In addition to the apparatus and bundles described above, the present invention also encompasses a method of making an apparatus for facilitating communication between care giver and patient. The method includes providing a donnable hospital garment, and placing at least one indicia in communication with the hospital garment, the at least one indicia displaying at least one care giver need or patient need and being adapted to aid in the rehabilitation and care of the patient.

1. An apparatus for facilitating communication between care giver and patient, the apparatus comprising:
a donnable hospital garment;
at least one indicia in communication with the hospital garment, the at least one indicia displaying at least one patient need and being adapted to aid in the rehabilitation and care of the patient.

2. The apparatus of claim 1, wherein the hospital garment comprises a patient gown or a cover gown.

3. The apparatus of claim 2, wherein the hospital garment comprises an SMS material, SFS material, spunbond material, meltblown material, or combinations thereof.

4. The apparatus of claim 3, wherein the at least one indicia is printed indicia displaced upon the hospital garment.

5. The apparatus of claim 3, wherein the at least one indicia is displaced upon the hospital garment by use of an adhesive.

6. The apparatus of claim 1, wherein the at least one patient need is food, water, pillows, change of positioning, relief from pain, mucous removal, medicine, family presence, radio, or television.

7. The apparatus of claim 6, wherein at least one patient need is grouped into at least one need category, the at least one category being comfort or entertainment.

8. The apparatus of claim 1, wherein the at least one indicia is in communication with at least one sleeve of the hospital garment.

9. The apparatus of claim 1, wherein the at least one indicia comprises at least one graphic illustration and at least one verbal illustration corresponding to the graphic illustration.

10. An apparatus for facilitating communication between care giver and patient, the apparatus comprising:
a donnable hospital garment;
at least one indicia in communication with the hospital garment, the at least one indicia displaying at least one care giver need and being adapted to aid in the rehabilitation and care of the patient

11. The apparatus of claim 10, wherein the hospital garment comprises a surgical gown or a cover gown.

12. The apparatus of claim 11, wherein the hospital garment comprises an SMS material, SFS material, spunbond material, meltblown material, or combinations thereof.

13. The apparatus of claim 12, wherein the at least one indicia is printed indicia displaced upon the hospital garment.

14. The apparatus of claim 12, wherein the at least one indicia is displaced upon the hospital garment by use of an adhesive.

15. The apparatus of claim 10, wherein the at least one care giver need is administering medication, changing patient positions, indicating procedure to be performed, or explaining possible results of procedures.

16. The apparatus of claim 15, wherein at least one care giver need is grouped into at least one need category, the at least one category being vital instruction or non-vital instructions.

17. The apparatus of claim 10, wherein the at least one indicia is in communication with at least one sleeve of the hospital garment.

18. The apparatus of claim 10, wherein the at least one indicia comprises at least one graphic illustration and at least one verbal illustration corresponding to the graphic illustration.

19. A patient communication bundle for facilitating communication between care giver and patient, the bundle comprising:
a donnable patient hospital garment;
a donnable care giver hospital garment;
at least one indicia in communication with the patient hospital garment, the at least one indicia displaying at least one patient need and being adapted to aid in the rehabilitation and care of the patient; and
at least one indicia in communication with the care giver hospital garment, the at least one indicia displaying at least one care giver need and being adapted to aid in the rehabilitation and care of the patient.

20. A method of making an apparatus for facilitating communication between care giver and patient, the method comprising:
providing a donnable hospital garment;
placing at least one indicia in communication with the hospital garment, the at least one indicia displaying at least one care giver need or patient need and being adapted to aid in the rehabilitation and care of the patient
